(19) United States
(12) Patent Application Publication
(10) Pub. No.: US 2004/0151567 A1
(43) Pub. Date: Aug. 5, 2004

(54) Terminal hinge for lift trucks having telescopic arms

(75) Inventor: Riccardo Magni, Modena (IT)

Correspondence Address: YOUNG & THOMPSON, 745 SOUTH 23RD STREET 2ND FLOOR, ARLINGTON, VA, 22202

(73) Assignee: MANITOU COSTRUZIONI INDUSTRIALI S.R.L., CASTELFRANCO EMILIA (MODENA) (IT)

(21) Appl. No.: 10/740,516

(22) Filed: Dec. 22, 2003

(30) Foreign Application Priority Data
Jan. 30, 2003 (IT) M02003A000021

(51) Int. Cl. B66F 1/00

(52) U.S. Cl. 414/664

(57) ABSTRACT

The hinge comprises a first link element and a second link element hinged to a free end of a telescopic arm of the lift truck. The first link element is commanded to oscillate about a hinge axis by first means for actuating acting between the free end and the first link element. The second link element, which supports a quick-release mechanism for a tool, is commanded to oscillate about the same hinge axis by second means for actuating acting between the first link element and the second link element.

### BACKGROUND OF THE INVENTION

Lift trucks with telescopic arm comprises a vehicle which at one end support a terminal part of a telescopic arm rotating on a vertical plane between a horizontal position and a practically vertical position. At a free end of the telescopic arm a quick-release tool is mounted, typically a forked support frame for raising loads on pallets from the truck level to higher levels, for example upper floors of a building. The quick-release mechanism is associated to the free end of the telescopic arm by means of a hinge which enables the tool to rotate on a vertical plane and has the aim of keeping the forks of the frame horizontal in all positions assumed by the telescopic arm. The range of oscillation of the support frame is therefore rather limited, which in turn limits the range of use of the lift truck to loading and raising operations of palletized loads with fork support frames. In particular, it is not practicable to use, for example, front loaders, which can substitute the frame very quickly thanks to the quick-release mechanism, and which can be used to load loose materials; it is impracticable because it is impossible to rotate and keep the mouth of the loader in an upwards-facing direction. For similar reasons, use of a forked support frame can be made safely only when the pallets to be raised are well balanced and bound, as the support frame cannot be rotated sufficiently to bring the forks into a position of safety, i.e. inclined upwards.

### SUMMARY OF THE INVENTION

The main aim of the present invention is to obviate the above-described drawbacks by providing a terminal hinge for lift trucks having telescopic arms which enables wide tool mobility in order that the truck can be used for a broad range of applications; in particular the tool can be rotated on a plane of over 90°.

### BRIEF DESCRIPTION of the DRAWINGS.

Further characteristics and advantages of the present invention will better emerge from the detailed description that follows of a terminal hinge for lift trucks having telescopic arms, illustrated purely by way of a non-limiting example in the accompanying figures of the drawings, in which:

FIG. 1 is a plan view of a hinge according to the present invention;

FIG. 1a is a view in section of the hinge of FIG. 1, according to line A-A;

FIG. 2 is the hinge of FIG. 1a in a maximum extension position;

FIG. 3 is the hinge of FIG. 1a in an intermediate extension position;

FIG. 4 is the hinge of FIG. 1a in a closed configuration.

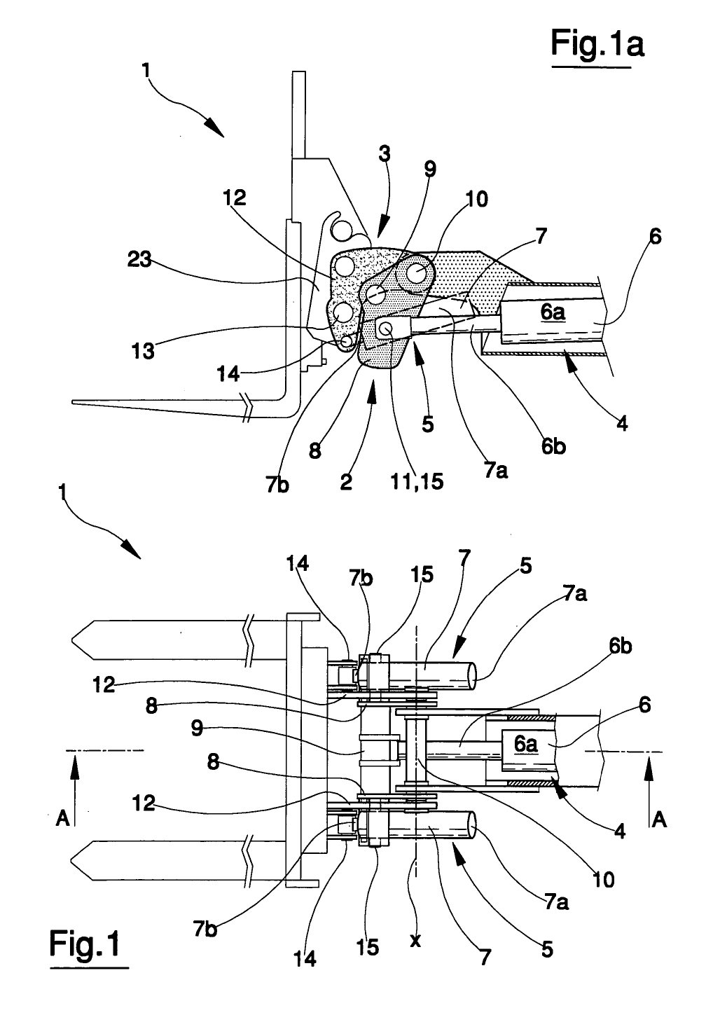

### DESCRIPTION of the PREFERRED EMBODIMENTS.

With reference to the figures of the drawings, 1 denotes in its entirety a hinge according to the present invention. It comprises a first link element 2 and a second link element 3 hinged to a free end 22 of the telescopic arm 21 of the lift truck 20. The first link element 2 is commanded to oscillate about a hinge axis x by first means for actuating 4 which act between the free end 22 and the first link element 2. The second link element 3, which supports a quick-release mechanism 23 for a tool, is commanded to oscillate about the same hinge axis x by second means for actuating 5 which act between the first link element 2 and the second link element 3. The hinge axis x lies in a perpendicular axis to the axis of the telescopic arm 21.

The first means for actuating 4 comprise at least a first hydraulic jack 6 which exhibits a cylinder 6a which is hinged to the telescopic arm 21 and an end of a stem 6b which is hinged to the first link element 2.

The second means for actuation 5 comprise at least a second hydraulic jack 7 which exhibits a cylinder 7a hinged to the first link element 2 and an end of a stem 7b which is hinged to the second link element 3. The second hydraulic jack 7 is hinged to the first link element 2 about an axis which is close to the hinge axis of the end of the stem 6b of the first hydraulic jack 6.

The first link element 2 comprises two plates 8, reciprocally facing and connected to one another by a crossbar 9 arranged perpendicular to the two plates 8. The two plates 8 are coupled in rotation to the free end 22 of the telescopic arm 21 by a first transversal pivot 10 which is coaxial to the hinge axis x, and the two plates are also coupled to the end of the stem 6b of the first hydraulic jack 6 by a second transversal pivot 11.

The second link element 3 comprises two curved plates 12 which face one another and which are connected one to another by a crossbar 13 arranged perpendicular to the two curved plates 12. The two curved plates 12 are coupled in rotation to the free end 22 of the telescopic arm 21 by the first transversal pivot 10 coaxial to the hinge axis x, and the curved part is predisposed to embrace, at least partially, the crossbar 9 of the first link element 2 in a position in which the stem 7b of the second hydraulic jack 7 is in a retracted position. The curved shape of the curved plates 12 enables the second link element 3, when the stem 7b of the second hydraulic jack 7 is retracted inside the cylinder 7a, to be positioned at least partially within the space of the first link element 2, resulting in a particularly compact configuration.

In the illustrated embodiment the second means for actuation 5 are two of the second hydraulic jack 7, having cylinders thereof hinged to a respective plate 8 of the first link element by coaxial first pivots 15, and having ends of the stems thereof hinged to a respective curved plate 12 of the second link element 3 by coaxial second pivots 14. Advantageously the first pivots 15 are coaxial to the second transversal pivot 11 in order to limit a surface of the plates 8 of the first link element 2 and to increase a compactness of the hinge.

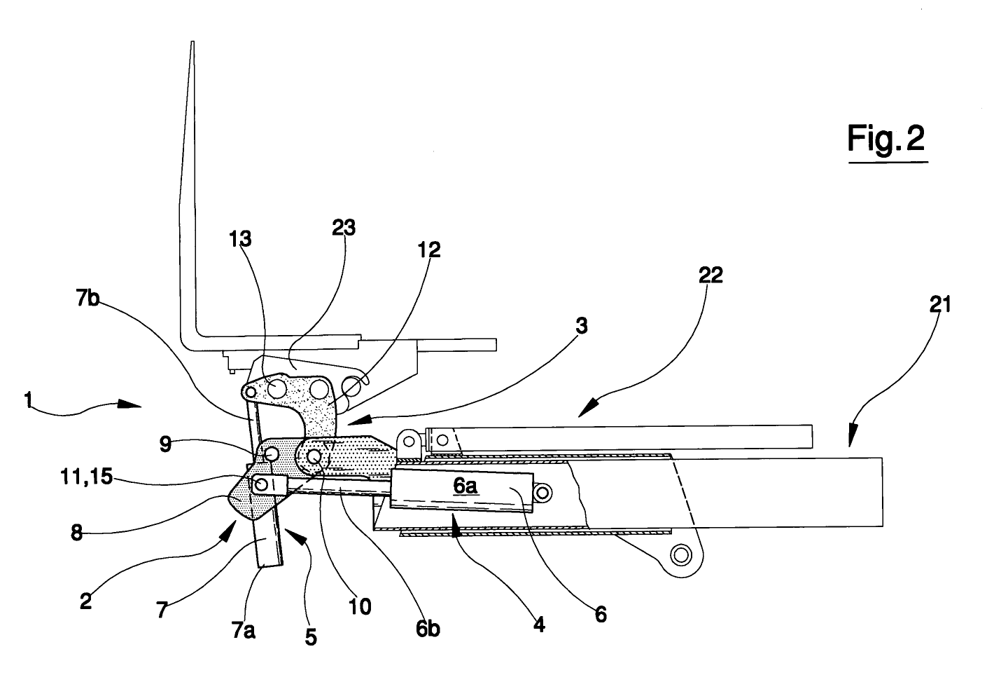

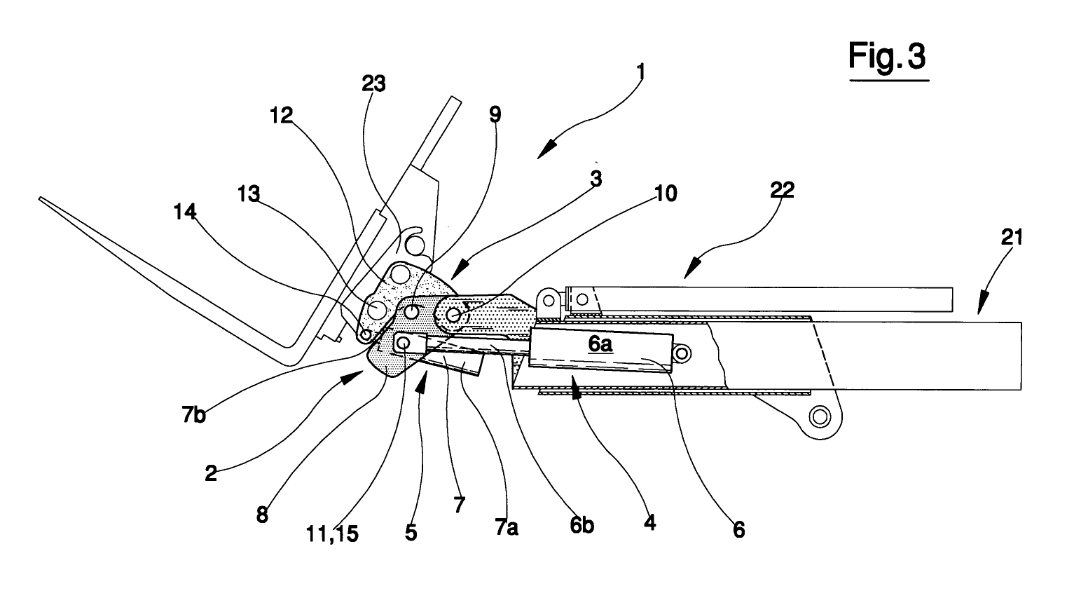

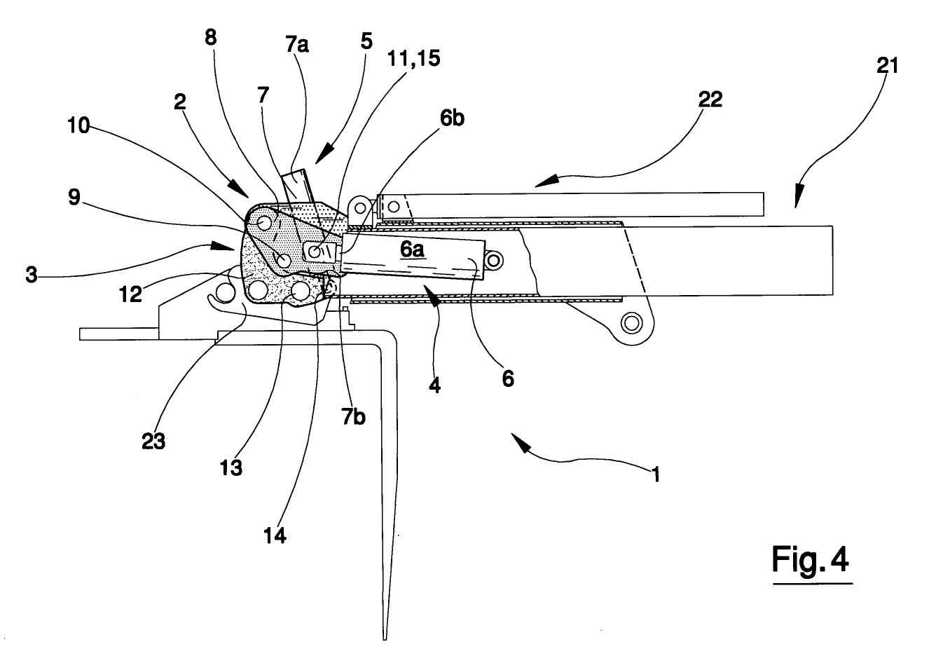

The hinge operates in an extremely simple and rational way. Starting from a “closed” configuration, such as the one illustrated in FIG. 3, the first hydraulic jack 6 rotates the first link element 2 about the pivot 10 by an angle of about 135° (FIG. 2), which angle is sufficient to enable a safe transport of a not-particularly well-balanced or compact pallet. Then, resuming from the configuration of FIG. 2, by extending the second hydraulic jack 7 or jacks, the second link element 3 can be rotated about the pivot 10 by and angle of about 45°, during which the quick-release mechanism 23 rotates by about 180°. The two above-described rotations can be synchronized or commanded independently to enable maximum flexibility of action.

The hinge of the present invention provides important advantages. Firstly, the tool attached to the end of the telescopic arm has a broad range of mobility, decidedly greater than hinges at present available. The architecture of the hinge is particularly compact and rigid, enabling use of tools of various types and of different dimensions.

Advantageously front loaders can be mounted on the quick-release mechanism for raising and lowering loose materials, as it is possible, thanks to the mobility of the hinge of the present invention, to rotate and maintain the mouth of the loader in an upwards-facing position. This advantage is also valid for forked support frames for moving pallets which are not well-balanced and bound, as the support frame can be rotated into a safety position in which the forks have their ends facing upwards.

What is claimed:

1). A terminal hinge for lift trucks having telescopic arms, comprising a first link element and a second link element hinged to a free end of a telescopic arm of the lift truck, the first link element being commanded to oscillate about a hinge axis by first means for actuating acting between the free end and the first link element; the second link element, which supports a quick-release mechanism for a tool, being commanded to oscillate about the hinge axis by second means for actuating acting between the first link element and the second link element.

2). The hinge of claim 1, wherein the first means for actuating comprise at least a first hydraulic jack having a cylinder hinged to the telescopic arm and an end of a stem hinged to the first link element.

3). The hinge of claim 2, wherein the second means for actuating comprise at least a second hydraulic jack having a cylinder hinged to the first link element and an end of a stem hinged to the second link element.

4). The hinge of claim 3, wherein the cylinder of the second hydraulic jack is hinged to the first link element about an axis which is in proximity of a hinge axis of the end of the stem of the first hydraulic cylinder.

5). The hinge of claim 4, wherein the hinge axis lies in a perpendicular plane to an axis of the telescopic arm.

6). The hinge of claim 5,wherein the first link element comprises two plates which face one another and which are connected to one another by a crossbar arranged perpendicular to the two plates, the two plates being coupled in rotation to the free end of the telescopic arm by a first transversal pivot which first transversal pivot is coaxial to the hinge axis; and the two plates being coupled to the end of the stem of the first hydraulic jack by a second transversal pivot.

7). The hinge of claim 6, wherein the second link element comprises two curved plates which face one another and which are connected to one another by a crossbar arranged perpendicular to the two curved plates, the two curved plates being coupled in rotation to the free end of the telescopic arm by the first transversal pivot which first transversal pivot is coaxial to the hinge axis; the two curved plates exhibiting concavities predisposed at least partially to embrace the crossbar of the first link element in a position in which the stem of the second hydraulic jack is retracted.

8). The hinge of claim 7, wherein the second means for actuating comprise two of the second hydraulic jack, each having the cylinder hinged to a respective plate of the two plates of the first link element by coaxial first pivots, and the end of the stem is hinged to a respective curved plate of the second link element by coaxial second pivots.

9). The hinge of claim 8,wherein the first pivots are coaxial to the second transversal pivot.
